(19) United States
(12) Patent Application Publication
(10) Pub. No.: US 2010/0040377 A1
(43) Pub. Date: Feb. 18, 2010

(54) Optical sensing module based on pulse width modulation signal and method thereof

(75) Inventors: Jinn-Ann Kuo, Sijhih City (TW); Cheng-Chung Shih, Fremont, CA (US); Yuh-Min Lin, San Ramon, CA (US); Chih-Cheng Chien, Taipei City (TW); Chien-Min Hsieh, Taipei City (TW)

Correspondence Address: BACON & THOMAS, PLLC, 625 SLATERS LANE, FOURTH FLOOR, ALEXANDRIA, VA, 22314-1176, US

(73) Assignee: CAPELLA MICROSYSTEMS(Taiwan),Ltd, SINDIAN CITY (TW)

(21) Appl. No.: 12/222,747

(22) Filed: Aug. 15, 2008

(51) Int. Cl. H04B 10/00

(52) U.S. Cl. 398/140; 398/189

(57) ABSTRACT

A optical sensing module based on signals having pulse width modulation and a method thereof are disclosed for sensing a light source and providing an output signal having pulse width modulation. The optical sensing module comprises an optical sensor, a signal processing unit, and a duty cycle modulation unit. The signal processing unit provides a modulation control signal based on a sensing signal generated by sensing the light source from the optical sensor in conjunction with a gain control signal. The duty cycle modulation unit modulates the duty cycle of the pulse width modulation input signal to generate the pulse width modulation output signal based on the modulation control signal. The duty cycle difference between the duty cycle of the input signal and the duty cycle of the output signal is proportional to the intensity difference between the light source and a reference light source.

### BACKGROUND OF THE INVENTION

1. Field of the Invention

The present invention relates to an optical sensing module, and more particularly to an optical sensing module based on a pulse width modulation (PWM) signal.

2. Description of the Related Art

In general, optical sensing components available in the market can be categorized into a switch output type and an analog output type based on the type of sensing output signals. For instance, an optical triac is a switch output type optical sensing component, and a light dependent resistor, an optical diode and an opticaltransistor are analog output type optical sensing components. The optical sensing components used in a general linear control system are mainly analog output type optical sensing components. Although a light dependent resistor gives the highest opticalsensitivity, the linearity between the variation of resistance and the light intensity of the light dependent resistor is deteriorated. If a sensing signal requires a high linearity, then the light dependent resistor can no longer meet the requirement. An opticaltransistor features a gain function and has a higher light sensitivity than the optical diode, but this advantage of the gain effect is accompanied with the increase of nonlinearity of the sensing signal, also influenced greatly by temperature.

Therefore, traditional optical sensing modules primarily use an optical diode as an optical sensing component for sensing a sensing voltage produced by optical current produced by an optical signal passing through a resistor, and the sensing voltage is outputted as an analog optical sensing signal. Since most of the present signal processors are digital signal processors, it is necessary to convert the analog optical sensing signal into a digital optical sensing signal by an analog-to-digital converter before the analog optical sensing signal is transmitted to a digital signal processor, but such arrangement will increase the complexity and cost of the sensing system, and the accuracy of the optical sensing signal will be reduced due to the sampling resolution of the analog-to-digital conversion process.

Since the white light emitting diode (WLED) is developed successfully, LEDs have replaced cold cathode fluorescent lamps (CCFL), and become a popular application of the LCD backlight source. In advanced digital signal processing systems, a driving signal for controlling the light intensity of an LED light source is mainly a pulse width modulation (PWM) signal. If an analog optical sensing signal outputted by a traditional optical sensing module is adapted for controlling the light intensity of the LED, it is necessary to have an additional signal processing circuit to convert the analog optical sensing signal into the pulse width modulation (PWM) signal, and further needs to develop a firmware to perform the signal conversion. However, the aforementioned arrangements will increase the complexity and cost of the system. Obviously, an optical sensing module directly compatible with the digital control system is needed.

In view of the foregoing shortcomings of the prior art, the inventor of the present invention based on years of experience in the related field to conduct extensive researches and experiments, and finally developed an optical sensing module based on a pulse width modulation (PWM) signal in accordance with the present invention to overcome the shortcomings of the prior art.

### SUMMARY OF THE INVENTION

Therefore, it is a primary objective of the present invention to provide an optical sensing module based on a pulse width modulation (PWM) signal and its related method for providing a pulse width modulation optical sensing output signal compatible to the digital control system and capable of directly driving and controlling the light intensity of a post-stage light source.

To achieve the foregoing objective, the present invention provides an optical sensing module for sensing a light source. The optical sensing module comprises an optical sensing circuit, a signal processing unit and a duty cycle modulation unit. The optical sensing circuit is for sensing the light source and generating an optical sensing signal. The signal processing unit is coupled to the optical sensing circuit and for receiving and processing the optical sensing signal to generate a modulation control signal. The duty cycle modulation unit is coupled to the signal processing unit and for receiving the modulation control signal and a pulse width modulation (PWM) input signal and modulating a duty cycle of the pulse width modulation input signal based on the modulation control signal to generate a pulse width modulation output signal.

Preferably, the optical sensing circuit, the signal processing unit and the duty cycle modulation unit can be integrated on one chip.

The present invention further provides an optical sensing processing method for receiving a pulse width modulation input signal and modulating a duty cycle of the pulse width modulation input signal based on a light intensity of a light source to generate a pulse width modulation output signal, and the optical sensing processing method comprises the steps of: using an optical sensing circuit to sense the light intensity of the light source to generate an optical sensing signal; using a subtraction circuit for performing a differential operation between the optical sensing signal and an adjustable reference signal to generate a differential signal; using a signal gain unit for performing a gain operation to the differential signal based on a gain control signal to generate a modulation control signal; and using a duty cycle modulation unit for performing a duty cycle modulation operation to a pulse width modulation input signal based on the modulation control signal to generate a pulse width modulation output signal.

### BRIEF DESCRIPTION OF THE DRAWINGS

FIG. 1 shows a schematic block diagram of an optical sensing module in accordance with the present invention;

FIG. 2 shows a schematic block diagram of a preferred embodiment of an optical sensing module in accordance with the present invention;

FIG. 3 shows a schematic block diagram of another preferred embodiment of an optical sensing module in accordance with the present invention;

FIG. 4 shows a schematic waveform diagram of related signal waveforms of an optical sensing signal SL, a gain control signal SG and an adjustable reference signal SR corresponding to a pulse width modulation input signal and a pulse width modulation output signal in accordance with the present invention; and

FIG. 5 shows a flow chart of an optical sensing processing method in accordance with the present invention.

### DETAILED DESCRIPTION OF THE PREFERRED EMBODIMENTS

To make it easier for the examiner to understand the structure, and overall operation of this invention, the invention is described in details with reference to certain illustrated embodiments accompanied by the drawings, but it is understood that these embodiments are not intended to limit the scope of the invention.

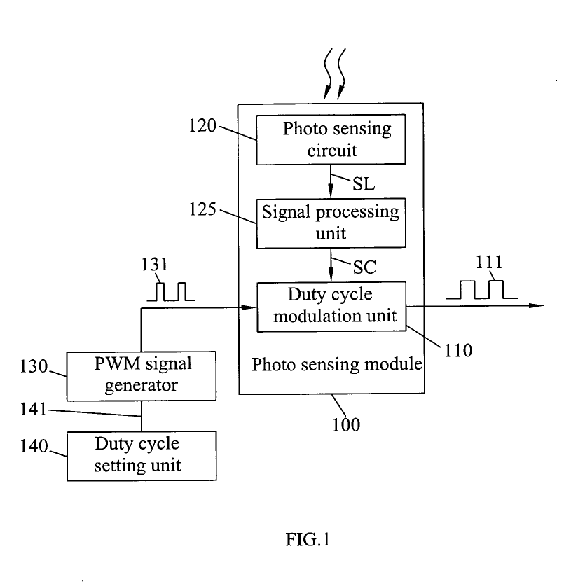

Referring to FIG. 1 for a schematic block diagram of an optical sensing module in accordance with the present invention, the optical sensing module 100 comprises a duty cycle modulation unit 110, an optical sensing circuit 120, and a signal processing unit 125. Preferably, the duty cycle modulation unit 110, the optical sensing circuit 120, and the signal processing unit 125 can be integrated on one chip.

The optical sensing circuit 120 is provided for sensing a light source and generating an optical sensing signal SL. Preferably, the optical sensing circuit 120 can be an optical diode sensing circuit, an opticaltransistor sensing circuit, a pyroelectric optical sensing circuit, or an opticalconductor sensing circuit. The optical sensing circuit 120 can comprise a preamplification circuit for performing a signal amplification operation to generate an optical sensing signal SL. And preferably, the preamplification circuit can be a transistor amplification circuit or an operational amplification circuit. The signal processing unit 125 receives an optical sensing signal SL and processes the optical sensing signal SL to generate a modulation control signal SC, and the signal processing unit 125 has a signal amplification function. The duty cycle modulation unit 110 receives a pulse width modulation (PWM) input signal 131 and a modulation control signal SC and modulates a duty cycle of the pulse width modulation input signal 131 based on the modulation control signal SC to generate a pulse width modulation output signal 111. The duty cycle difference between the duty cycle of the pulse width modulation output signal 111 and the duty cycle of the pulse width modulation input signal 131 is controlled by the optical sensing signal SL.

The pulse width modulation input signal 131 can be generated by a pulse width modulation (PWM) signal generator 130. In other words, the pulse width modulation (PWM) signal generator 130 is coupled to the duty cycle modulation unit 110 for generating and providing the pulse width modulation input signal 131 to the duty cycle modulation unit 110. Further, a duty cycle setting unit 140 is electrically coupled to the pulse width modulation (PWM) signal generator 130 for setting a duty cycle setting signal 141, and the pulse width modulation (PWM) signal generator 130 can set the duty cycle of the generated pulse width modulation input signal 131 based on the duty cycle setting signal 141, and the duty cycle of the pulse width modulation input signal 131 corresponds to a reference light intensity.

The related operating principle of the optical sensing module 100 is described as the following. The optical sensing circuit 120 senses the light source and generates an optical sensing signal SL, and the signal processing unit 125 processes the optical sensing signal SL to generate a modulation control signal SC, and the duty cycle modulation unit 110 receives a pulse width modulation input signal 131 and a modulation control signal SC and modulates a duty cycle of the pulse width modulation input signal 131 based on the modulation control signal SC to generate the pulse width modulation output signal 111.

If the light intensity of the light source is equal to the reference light intensity, then the duty cycle of the pulse width modulation output signal 111 is equal to the duty cycle of pulse width modulation input signal 131. If the light intensity of the light source is smaller than the reference light intensity, then the duty cycle of the pulse width modulation output signal 111 is smaller than the duty cycle of the pulse width modulation input signal 131, and the duty cycle difference between the duty cycle of the pulse width modulation output signal 111 and the duty cycle of the pulse width modulation input signal 131 is directly proportional to the difference between the light intensity of the light source and the reference light intensity. If the light intensity of the light source is greater than the reference light intensity, then the duty cycle of the pulse width modulation output signal 111 is greater than the duty cycle of the pulse width modulation input signal 131, and the duty cycle difference between the duty cycle of the pulse width modulation output signal 111 and the duty cycle of the pulse width modulation input signal 131 is also directly proportional to the difference between the light intensity of the light source and the reference light intensity.

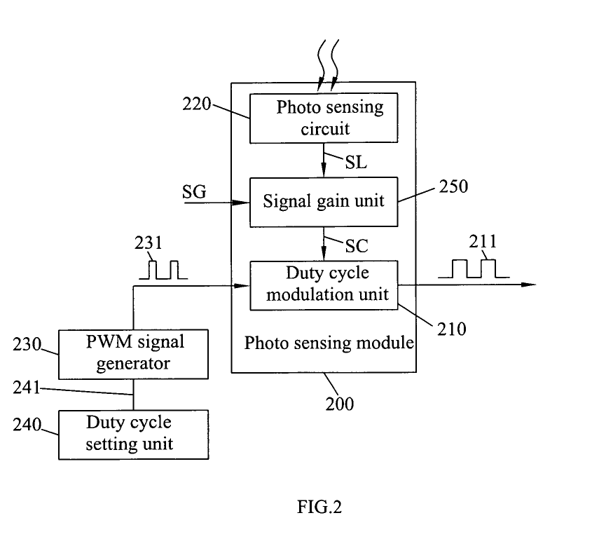

Referring to FIG. 2 for a schematic block diagram of a preferred embodiment of an optical sensing module in accordance with the present invention, the optical sensing module 200 comprises a duty cycle modulation unit 210, an optical sensing circuit 220, and a signal gain unit 250. Preferably, the duty cycle modulation unit 210, the optical sensing circuit 220, and the signal gain unit 250 can be integrated on one chip.

The optical sensing circuit 220 is provided for sensing a light source and generating an optical sensing signal SL. Preferably, the optical sensing circuit 220 can be an optical diode sensing circuit, an opticaltransistor sensing circuit, a pyroelectric optical sensing circuit, or an opticalconductor sensing circuit. The optical sensing circuit 220 can comprise a preamplification circuit for performing a preamplification operation to generate an optical sensing signal SL, and the preamplification circuit can be a transistor amplification circuit or an operational amplification circuit.

The signal gain unit 250 receives the optical sensing signal SL and a gain control signal SG for performing a differential gain operation between the optical sensing signal SL and a predetermined reference signal SP based on the gain control signal SG to generate a modulation control signal SC, and the signal gain unit 250 can be an operational amplifier differential amplification circuit or even a high gain differential amplification circuit, and the gain control signal SG is provided for controlling a variance of resistances of the operational amplifier differential amplification circuit or the high gain differential amplification circuit to control the gain value. The operational amplifier differential amplification circuit and the high gain differential amplification circuit are prior arts and thus will not be described here.

The duty cycle modulation unit 210 receives a pulse width modulation (PWM) input signal 231 and a modulation control signal SC and then modulates the duty cycle of the pulse width modulation input signal 231 based on the modulation control signal SC to generate a pulse width modulation output signal 211. The duty cycle difference between the duty cycle of the pulse width modulation output signal 211 and the duty cycle of the pulse width modulation input signal 231 is controlled by the optical sensing signal SL and the gain control signal SG.

Similarly, the pulse width modulation input signal 231 can be generated by a pulse width modulation (PWM) signal generator 230. In other words, the pulse width modulation (PWM) signal generator 230 is coupled to the duty cycle modulation unit 210 for providing the generated pulse width modulation input signal 231 to the duty cycle modulation unit 210. A duty cycle setting unit 240 is provided for setting and providing a duty cycle setting signal 241 to the pulse width modulation (PWM) signal generator 230, and the pulse width modulation (PWM) signal generator 230 sets the duty cycle of the generated pulse width modulation input signal 231 based on the duty cycle setting signal 241, and the duty cycle of the pulse width modulation input signal 231 corresponds to the predetermined reference signal SP.

The related operating principle of the optical sensing module 200 is described as follows. The optical sensing circuit 220 senses the light source and generates an optical sensing signal SL, and the signal gain unit 250 receives the optical sensing signal SL and a gain control signal SG and performs a differential gain operation between the optical sensing signal SL and the predetermined reference signal SP based on the gain control signal SG to generate a modulation control signal SC, and the duty cycle modulation unit 210 receives the pulse width modulation input signal 231 and the modulation control signal SC and modulates the duty cycle of the pulse width modulation input signal 231 based on the modulation control signal SC to generate a pulse width modulation output signal 211.

If the light intensity of the light source is equal to the light intensity corresponding to the predetermined reference signal SP, then the duty cycle of the pulse width modulation output signal 211 is equal to the duty cycle of the pulse width modulation input signal 231. If the light intensity of the light source is smaller than the light intensity corresponding to the predetermined reference signal SP, then the duty cycle of the pulse width modulation output signal 211 is smaller than the duty cycle of the pulse width modulation input signal 231, and the duty cycle difference TD between the duty cycle of the pulse width modulation output signal 211 and the duty cycle of the pulse width modulation input signal 231 is directly proportional to the difference between the optical sensing signal SL and the predetermined reference signal SP, i.e. TD=α(SL−SP), where the constant proportional coefficient α is controlled by the gain control signal SG. In the meantime, the duty cycle difference TD is negative, which indicates that the duty cycle is decreased. If the light intensity of the light source is greater than the light intensity corresponding to the predetermined reference signal SP, then the duty cycle of the pulse width modulation output signal 211 is greater than the duty cycle of the pulse width modulation input signal 231, and the duty cycle difference TD between the duty cycle of the pulse width modulation output signal 211 and the duty cycle of the pulse width modulation input signal 231 is still the same as the described above, i.e. TD=α(SL−SP). In the meantime, the duty cycle difference TD is positive, which indicates that the duty cycle is increased.

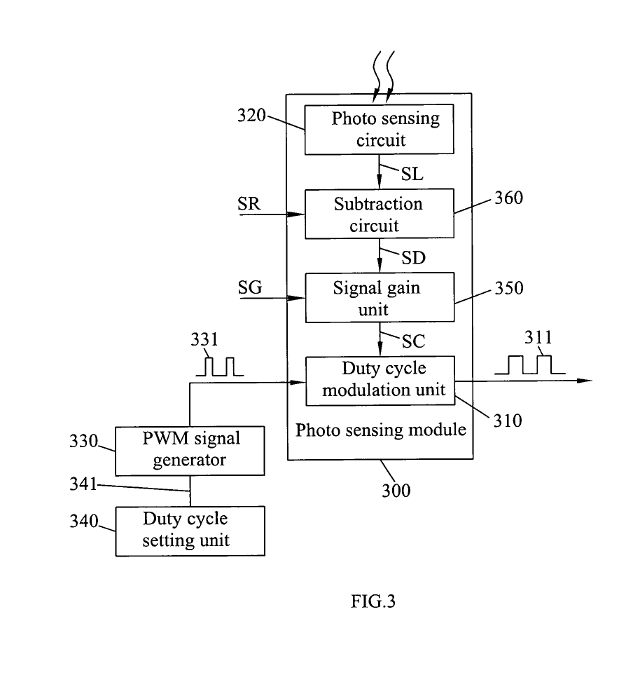

Referring to FIG. 3 for a schematic block diagram of another preferred embodiment of an optical sensing module in accordance with the present invention, the optical sensing module 300 comprises a duty cycle modulation unit 310, an optical sensing circuit 320, a signal gain unit 350 and a subtraction circuit 360. Preferably, the duty cycle modulation unit 310, the optical sensing circuit 320, the signal gain unit 350, and the subtraction circuit 360 can be integrated on one chip.

The optical sensing circuit 320 is provided for sensing a light source and generates an optical sensing signal SL, and the optical sensing circuit 320 can be an optical diode sensing circuit, an opticaltransistor sensing circuit, a pyroelectric optical sensing circuit, or an opticalconductor sensing circuit. The optical sensing circuit 320 includes a preamplification circuit for performing a signal amplification operation to generate an optical sensing signal SL, and the preamplification circuit can be a transistor amplification circuit or an operational amplification circuit.

The subtraction circuit 360 receives the optical sensing signal SL and an adjustable reference signal SR for performing a differential operation between the optical sensing signal SL and the adjustable reference signal SR to generate a differential signal SD, wherein the adjustable reference signal SR corresponds to an adjustable reference light intensity, and the subtraction circuit 360 can be an operational amplifier subtraction circuit. The operational amplifier subtraction circuit is a prior art, and thus will not be described here.

The signal gain unit 350 receives the differential signal SD and a gain control signal SG for performing a gain operation of the differential signal SD based on the gain control signal SG to generate a modulation control signal SC, and the signal gain unit 350 can be an operational amplification circuit, and the gain control signal SG is provided for controlling a difference of resistances of the operational amplification circuit to control a gain value. The signal gain unit 350 can be a multiplication circuit for performing a multiplication operation between the differential signal SD and the gain control signal SG to generate a modulation control signal SC. The duty cycle modulation unit 310 receives a pulse width modulation (PWM) input signal 331 and the modulation control signal SC and modulates the duty cycle of the pulse width modulation input signal 331 based on the modulation control signal SC to generate a pulse width modulation output signal 311, and the duty cycle difference between the duty cycle of the pulse width modulation output signal 311 and the duty cycle of the pulse width modulation input signal 331 is controlled by the optical sensing signal SL, the gain control signal SG and the adjustable reference signal SR.

Similarly, the pulse width modulation input signal 331 can be generated by a pulse width modulation (PWM) signal generator 330. In other words, the pulse width modulation (PWM) signal generator 330 is coupled to the duty cycle modulation unit 310 for providing the generated pulse width modulation input signal 331 to the duty cycle modulation unit 310. A duty cycle setting unit 340 is provided for setting and outputting a duty cycle setting signal 341 to the pulse width modulation (PWM) signal generator 330, and the pulse width modulation (PWM) signal generator 330 sets the duty cycle of the generated pulse width modulation input signal 331 based on the duty cycle setting signal 341, and the duty cycle of the pulse width modulation input signal 331 corresponds to the adjustable reference signal SR.

The related operating principle of the optical sensing module 300 is described as follows. The optical sensing circuit 320 senses a light source and generates an optical sensing signal SL, and the subtraction circuit 360 performs a differential operation between the optical sensing signal SL and the adjustable reference signal SR to generate a differential signal SD, i.e. SD=SL−SR. The signal gain unit 350 performs a gain operation of the differential signal SD to generate the modulation control signal SC, i.e. SC=αSD=α(SL−SR), where the constant proportional coefficient α is controlled by the gain control signal SG The duty cycle modulation unit 310 receives the pulse width modulation input signal 331 and the modulation control signal SC and modulates the duty cycle of the pulse width modulation input signal 331 based on the modulation control signal SC to generate a pulse width modulation output signal 311.

If the light intensity of the light source is equal to the light intensity corresponding to the adjustable reference signal SR, then the duty cycle of the pulse width modulation output signal 311 is equal to the duty cycle of the pulse width modulation input signal 331. If the light intensity of the light source is smaller than the light intensity corresponding to the adjustable reference signal SR, then the duty cycle of the pulse width modulation output signal 311 is smaller than the duty cycle of the pulse width modulation input signal 331, and the duty cycle difference TD between the duty cycle of the pulse width modulation output signal 311 and the duty cycle of the pulse width modulation input signal 331 is directly proportional to the difference between the optical sensing signal SL and the adjustable reference signal SR, i.e. TD=α(SL−SR), wherein the constant proportional coefficient α is controlled by the gain control signal SG. In the meantime, the duty cycle difference TD is negative, which indicates that the duty cycle is decreased. If the light intensity of the light source is greater than the light intensity corresponding to the adjustable reference signal SR, then the duty cycle of the pulse width modulation output signal 311 is greater than the duty cycle of the pulse width modulation input signal 331, and the duty cycle difference TD between the duty cycle of the pulse width modulation output signal 311 and the duty cycle of the pulse width modulation input signal 331 is the same as the described above, i.e. TD=α(SL−SR). In the meantime, the duty cycle difference TD is positive, which indicates that the duty cycle is increased.

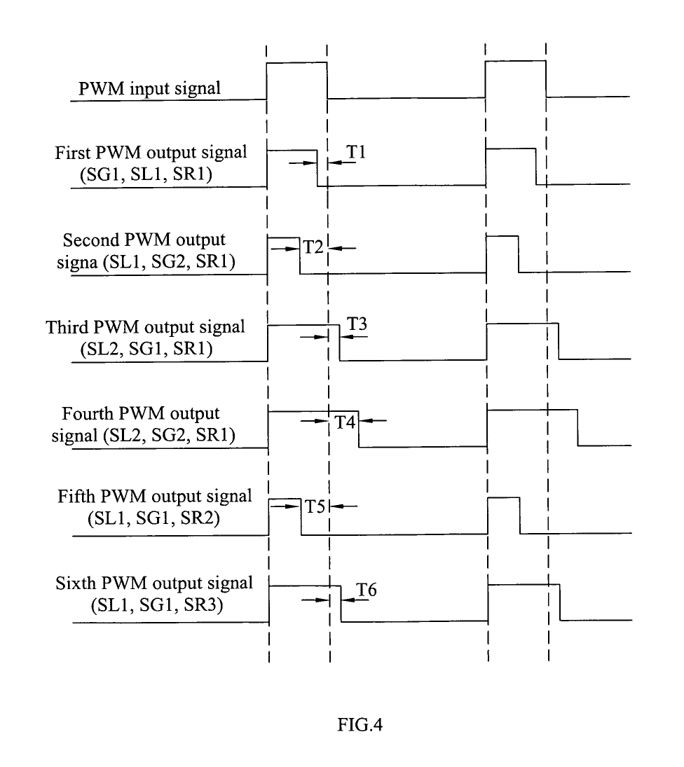

Referring to FIG. 4 for a schematic waveform diagram of related signal waveforms of an optical sensing signal SL, a gain control signal SG and an adjustable reference signal SR corresponding to a pulse width modulation input signal and a pulse width modulation output signal in accordance with the present invention, related waveforms show a pulse width modulation input signal waveform diagram, a first pulse width modulation output signal waveform diagram, a second pulse width modulation output signal waveform diagram, a third pulse width modulation output signal waveform diagram, a fourth pulse width modulation output signal waveform diagram, a fifth pulse width modulation output signal waveform diagram and a sixth pulse width modulation output signal waveform diagram from the top to the bottom of the figure.

The first pulse width modulation output signal waveform diagram corresponds to the optical sensing signal SL1, the gain control signal SG1 and the adjustable reference signal SR1, wherein the light intensity of the light source corresponding to the optical sensing signal SL1 is smaller than the reference light intensity corresponding to the adjustable reference signal SR1. Therefore, the duty cycle of the first pulse width modulation output signal is smaller than the duty cycle of the pulse width modulation input signal by a duty cycle difference T1. The second pulse width modulation output signal waveform diagram corresponds to the optical sensing signal SL1, the gain control signal SG2 and the adjustable reference signal SR1, and the second pulse width modulation output signal and the first pulse width modulation output signal correspond to the same optical sensing signal SL1 and adjustable reference signal SR1, but the gain control signal SG2 corresponding to the second pulse width modulation output signal is greater than the gain control signal SG1 corresponding to the first pulse width modulation output signal. Therefore, the duty cycle of the second pulse width modulation output signal is less than the duty cycle of the pulse width modulation input signal by a duty cycle difference T2 which is greater than the duty cycle difference T1.

The third pulse width modulation output signal waveform diagram corresponds to the optical sensing signal SL2, the gain control signal SG1 and the adjustable reference signal SR1, and the third pulse width modulation output signal and the first pulse width modulation output signal correspond to the same gain control signal SG1 and adjustable reference signal SR1, but the light intensity of the light source corresponding to the optical sensing signal SL2 is greater than the reference light intensity corresponding to the adjustable reference signal SR1. Therefore, the duty cycle of the third pulse width modulation output signal is greater than the duty cycle of the pulse width modulation input signal by a duty cycle difference T3. The fourth pulse width modulation output signal waveform diagram corresponds to the optical sensing signal SL2, the gain control signal SG2 and the adjustable reference signal SR1, and the fourth pulse width modulation output signal and the third pulse width modulation output signal correspond to the same optical sensing signal SL2 and adjustable reference signal SR1, but the gain control signal SG2 corresponding to the fourth pulse width modulation output signal is greater than the gain control signal SG1 corresponding to the third pulse width modulation output signal. Therefore, the duty cycle of the fourth pulse width modulation output signal is greater than the duty cycle of the pulse width modulation input signal by a duty cycle difference T4 which is greater than the duty cycle difference T3.

The fifth pulse width modulation output signal waveform diagram corresponds to the optical sensing signal SL1, the gain control signal SG1 and the adjustable reference signal SR2, and the fifth pulse width modulation output signal and the first pulse width modulation output signal correspond to the same optical sensing signal SL1 and gain control signal SG1, but the adjustable reference signal SR2 corresponding to the fifth pulse width modulation output signal is greater than the adjustable reference signal SR1 corresponding to the first pulse width modulation output signal. Although the light intensity of the light source is the same, the difference between the light intensity of the light source and the reference light intensity corresponding to the adjustable reference signal SR2 is greater than the difference between the light intensity of the light source and the reference light intensity corresponding to the adjustable reference signal SR1. Therefore, the duty cycle of the fifth pulse width modulation output signal is smaller than the duty cycle of the pulse width modulation input signal by a duty cycle difference T5 which is greater than the duty cycle difference T1.

The sixth pulse width modulation output signal waveform diagram corresponds to the optical sensing signal SL1, the gain control signal SG1 and the adjustable reference signal SR3, and the sixth pulse width modulation output signal and the first pulse width modulation output signal correspond to the same optical sensing signal SL1 and gain control signal SG1, but the adjustable reference signal SR3 corresponding to the sixth pulse width modulation output signal is smaller than the adjustable reference signal SR1 corresponding to the first pulse width modulation output signal, and the reference light intensity corresponding to the adjustable reference signal SR3 is also smaller than the light intensity of the light source corresponding to the optical sensing signal SL1. Although the light intensity of the light source is the same, but the duty cycle of the sixth pulse width modulation output signal is greater than the duty cycle of the pulse width modulation input signal by a duty cycle difference T6.

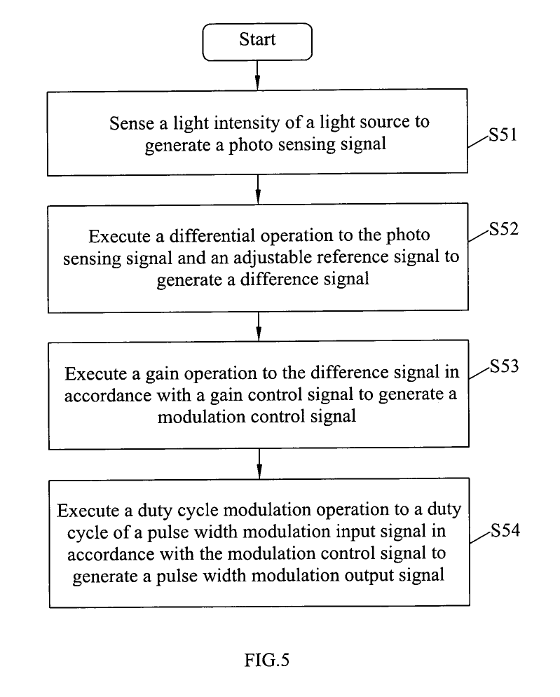

Referring to FIG. 5 for a flow chart of an optical sensing processing method in accordance with the present invention, the optical sensing processing method is provided for receiving a pulse width modulation input signal and modulating a duty cycle of the pulse width modulation input signal based on a light intensity of a light source to generate a pulse width modulation output signal, and the optical sensing processing method comprises the steps of:

S501: using an optical sensing circuit to sense the light intensity of a light source to generate an optical sensing signal;

S502: using a subtraction circuit to perform a differential operation between the optical sensing signal and an adjustable reference signal to generate a differential signal;

S503: using a signal gain unit to perform a gain operation of the differential signal based on a gain control signal to generate a modulation control signal; and

S504: using a duty cycle modulation unit to perform a duty cycle modulation operation of a duty cycle of a pulse width modulation input signal based on the modulation control signal to generate a pulse width modulation output signal.

Preferably, the step S501 further comprises a step of using the optical sensing circuit to perform a preamplification operation to generate the optical sensing signal. In the step S504, a duty cycle modulation unit used for performing a duty cycle modulation operation to the duty cycle of a pulse width modulation input signal based on the modulation control signal to generate a pulse width modulation output signal is to use the modulation control signal to control the duty cycle difference between the duty cycle of the pulse width modulation input signal and the duty cycle of the pulse width modulation output signal, such that the duty cycle difference is directly proportional to the modulation control signal.

Only some embodiments of the present invention have been illustrated in the drawings, but it should be pointed out that many other modifications are conceivable within the scope of the following claims.

What is claimed is:

1. An optical sensing module for sensing a light source, comprising:
an optical sensing circuit, for sensing the light source and generating an optical sensing signal;
a signal processing unit, coupled to the optical sensing circuit, for receiving and processing the optical sensing signal to generate a modulation control signal; and
a duty cycle modulation unit, coupled to the signal processing unit, for receiving the modulation control signal and a pulse width modulation (PWM) input signal, and modulating a duty cycle of the pulse width modulation input signal based on the modulation control signal to generate a pulse width modulation output signal.

2. The optical sensing module of claim 1, wherein the optical sensing circuit, the signal processing unit, and the duty cycle modulation unit are integrated on a chip.

3. The optical sensing module of claim 1, wherein the optical sensing circuit is an optical diode sensing circuit.

4. The optical sensing module of claim 1, wherein the optical sensing circuit is an optical transistor sensing circuit.

5. The optical sensing module of claim 1, wherein the optical sensing circuit is a pyroelectric optical sensing circuit.

6. The optical sensing module of claim 1, wherein the optical sensing circuit is an opticalconductor sensing circuit.

7. The optical sensing module of claim 1, wherein the optical sensing circuit includes a preamplification circuit.

8. The optical sensing module of claim 7, wherein the preamplification circuit is a transistor amplification circuit.

9. The optical sensing module of claim 1, wherein the signal processing unit comprises a signal gain unit coupled to the optical sensing circuit, and the signal gain unit is for receiving the optical sensing signal and a gain control signal, and for performing a differential gain operation between the optical sensing signal and a predetermined reference signal based on the gain control signal to generate the modulation control signal, and the predetermined reference signal corresponds to a predetermined reference light intensity.

10. The optical sensing module of claim 9, wherein a duty cycle difference between a duty cycle of the pulse width modulation output signal and a duty cycle of the pulse width modulation input signal generated by the duty cycle modulation unit is directly proportional to a signal difference between the optical sensing signal and the predetermined reference signal.

11. The optical sensing module of claim 10, wherein the gain control signal received by the signal gain unit is a constant proportional coefficient of the duty cycle difference and the signal difference.

12. The optical sensing module of claim 9, wherein the signal gain unit is an operational amplifier differential amplification circuit, and the gain control signal is for controlling a variation of resistances of the operational amplifier differential amplification circuit to control a gain value.

13. The optical sensing module of claim 1, wherein the signal processing unit comprises:
a subtraction circuit, coupled to the optical sensing circuit, for receiving the optical sensing signal and an adjustable reference signal corresponding to an adjustable reference light intensity, and the subtraction circuit performing a differential operation between the optical sensing signal and the adjustable reference signal to generate a differential signal; and
a signal gain unit, coupled to the subtraction circuit for receiving the differential signal and a gain control signal, and performing a gain operation to the differential signal based on the gain control signal to generate the modulation control signal.

14. The optical sensing module of claim 13, wherein a duty cycle difference between a duty cycle of the pulse width modulation output signal and a duty cycle of the pulse width modulation input signal generated by the duty cycle modulation unit is directly proportional to a signal difference between the optical sensing signal and the predetermined reference signal.

15. The optical sensing module of claim 14, wherein the gain control signal received by the signal gain unit is a constant proportional coefficient of the duty cycle difference and the signal difference.

16. The optical sensing module of claim 13, wherein the subtraction circuit is an operational amplifier subtraction circuit.

17. The optical sensing module of claim 13, wherein the signal gain unit is an operational amplification circuit, and the gain control signal is for controlling a difference of resistances of the operational amplification circuit to control a gain value.

18. The optical sensing module of claim 13, wherein the signal gain unit is a multiplication circuit for performing a multiplication operation between the differential signal and the gain control signal to generate the modulation control signal.

19. A optical sensing processing method for receiving a pulse width modulation input signal, and modulating a duty cycle of the pulse width modulation input signal based on a light intensity of a light source to generate a pulse width modulation output signal, and the optical sensing processing method comprising the steps of:
(a) using an optical sensing circuit to sense the light intensity of the light source to generate an optical sensing signal;
(b) using a subtraction circuit to perform a differential operation between the optical sensing signal and an adjustable reference signal to generate a differential signal;
(c) using a signal gain unit to perform a gain operation to the differential signal based on a gain control signal to generate a modulation control signal; and
(d) using a duty cycle modulation unit to perform a duty cycle modulation operation to the pulse width modulation input signal based on the modulation control signal to generate the pulse width modulation output signal.

20. The optical sensing processing method of claim 19, wherein the Step (a) further comprises the step of: using the optical sensing circuit to perform a preamplification operation to generate the optical sensing signal.
